(19) United States
(12) Patent Application Publication
(10) Pub. No.: US 2026/0195328 A1
(43) Pub. Date: Jul. 9, 2026

(54) DYNAMIC GRAPH SCALING SEARCH FOR COMPLEX STRUCTURED QUERY LANGUAGE GENERATION BASED ON GRAPH DATABASE AND LARGE LANGUAGE MODEL

(71) Applicant: INTERNATIONAL BUSINESS MACHINES CORPORATION, ARMONK, NY (US)

(72) Inventors: Yong Wang, Xi'an (CN); Rui Han, Xi'an (CN); Yuan Yuan Ding, Shanghai (CN); Qi Liang Zhou, Xi'an (CN); Deng Xin Luo, XIAN (CN)

(21) Appl. No.: 19/013,937

(22) Filed: Jan. 8, 2025

(51) Int. Cl. G06F 16/2453; G06F 16/242; G06F 16/901

(52) U.S. Cl. CPC G06F 16/24542; G06F 16/243; G06F 16/9024

(57) ABSTRACT

Provided are a method, system, and computer program product in which entities from a database are defined and extracted, based on semantic information, via a large language model (LLM). Data for structured query language (SQL) generation is generated to incorporate into a multi-layer semantic routable graph. Nodes related to user queries are determined based on the multi-layer semantic routable graph.

### BACKGROUND

Embodiments relate to a method, system, and computer program product for dynamic graph scaling search for complex structured query language generation based on graph database and large language model.

Structured Query Language (SQL) is a language used to manage data, and commonly used in a relational database management system (RDBMS). SQL may be useful for handling structured data, where the structured data incorporates relations among entities and variables. Simple SQL queries are commands that perform straightforward data retrieval, usually from only one table at a time, whereas complex SQL queries go beyond the standard commands by retrieving data from a plurality of tables and by limiting the result set with multiple conditions.

A large language model (LLM) is a type of computational model for natural language processing (NLP) tasks such as language generation. LLMs may perform NLP tasks by learning statistical relationships from vast amounts of text during a training process. Certain LLMs are artificial neural networks built with a decoder-only transformer-based architecture. LLMs may be fine-tuned for specific tasks, or be guided by prompt engineering.

A graph database is a type of database that uses a graph model to store and represent data, and may be optimized for connected data. Graph databases are different from relational databases that store data in tables, with the graph databases using a network of entities and relationships to store data. A graph database uses graph structures with nodes, edges, and properties to represent and store data. The graph relates the data items in a database to a collection of nodes and edges, where the edges represent the relationships between the nodes.

### SUMMARY

Provided are a method, system, and computer program product in which entities from a database are defined and extracted, based on semantic information, via a large language model (LLM). Data for structured query language (SQL) generation is generated to incorporate into a multi-layer semantic routable graph. Nodes related to user queries are determined based on the multi-layer semantic routable graph.

In additional embodiments, the LLM is used to build the multi-layer semantic routable graph based on table schema, description of tables and columns, and SQL syntax operation commands.

In yet additional embodiments, the multi-layer semantic routable graph stores a schema of a table, and relationships between different tables.

In further embodiments, the LLM is utilized to expand, refine, and decompose user query tasks.

In certain embodiments, the multi-layer semantic routable graph is used to filter nodes that are strongly related to each query sub-task.

In further embodiments, a ternary graph is defined to represent relationships between tables and SQL keywords to generate complex SQL.

In yet further embodiments, a process performs operations for dynamic graph scaling for graph search to generate SQL generation based on a calculated subgraph and determines a final SQL statement.

### BRIEF DESCRIPTION OF THE DRAWINGS

Referring now to the drawings in which like reference numbers represent corresponding parts throughout:

FIG. 1 illustrates a computing environment, in accordance with certain embodiments.

FIG. 2 illustrates a block diagram that shows the building of a hierarchical graph based on database structure information, in accordance with certain embodiments.

FIG. 3 illustrates a block diagram that shows a SQL syntax keyword node, in accordance with certain embodiments.

FIG. 4 illustrates a block diagram that shows a ternary relationship among three kinds of nodes, in accordance with certain embodiments.

FIG. 5 illustrates a block diagram that shows semantic relationships, in accordance with certain embodiments.

FIG. 6 illustrates a block diagram that shows association relationship based upon historical query, in accordance with certain embodiments.

FIG. 7 illustrates a block diagram that shows the building of a basic nodes graph, in accordance with certain embodiments.

FIG. 8 illustrates a block diagram that shows dynamic graph scaling search operations, in accordance with certain embodiments.

FIG. 9 illustrates a flowchart that shows exemplary operations, in accordance with certain embodiments.

FIG. 10 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Several examples will now be provided to further clarify various aspects of the present invention:
Example 1: A method in which entities from a database are defined and extracted, based on semantic information, via a large language model (LLM). Data for structured query language (SQL) generation is generated to incorporate into a multi-layer semantic routable graph. Nodes related to user queries are determined based on the multi-layer semantic routable graph. As a result, user queries may be understood and analyzed.
Example 2: The limitations of Example 1, in which the LLM is used to build the multi-layer semantic routable graph based on table schema, description of tables and columns, and SQL syntax operation commands. As a result, the LLM augments tables and table schemas to analyze user queries.
Example 3: The limitations of any of Examples 1-2, in which the multi-layer semantic routable graph stores a schema of a table, and relationships between different tables. As a result, a better understanding is achieved of user queries.
Example 4: The limitations of any of Examples 1-3, in which the LLM is utilized to expand, refine, and decompose user query tasks. As a result, LLMs are applied to refine user query tasks.
Example 5: The limitations of any of Examples 1-4, in which the multi-layer semantic routable graph is used to filter nodes that are strongly related to each query sub-task. As a result, nodes that are related to query sub-tasks are determined.
Example 6: The limitations of any of Examples 1-5, in which a ternary graph is defined to represent relationships between tables and SQL keywords to generate complex SQL. As a result, complex SQL statements are generated.
Example 7: The limitations of any of Examples 1-6, in which a process performs operations for dynamic graph scaling for graph search to generate SQL generation based on a calculated subgraph and determines a final SQL statement. As a result, dynamic graph scaling for graph search is performed.
Example 8: A system, comprising a memory and a processor coupled to the memory, where the processor performs a method according to any of Examples 1-7.
Example 9: A computer program product comprising a computer readable storage medium having computer readable program code embodied therewith, where the computer readable program code when executed by a processor is configured to perform a method according to any of Examples 1-7.

Generating SQL with the help of LLM and using the generated SQL to query data from a database may be employed in certain applications. For generating accurate SQL statements based on existing data, a process may need to provide the LLM with Table schemas, Table descriptions and Relations across tables. However, this mechanism has many limitations when dealing with large databases. For example, due to the length limit of the input token, it may become impossible for a process to provide the full information about a database in a model prompt. It is challenging to accurately find the related tables and columns to user queries from the large database to streamline the input token for generating the accurate SQL statements. Based on the obtained target Tables and Columns, in order to generate executable SQL, there are still multiple limitations when using the LLMs, such as multi-table joins, dimension summarization and Complex Key performance indicators (KPI) calculations.

When dealing with the large database scenario, it is not realistic to provide all the information about the tables in a prompt. Instead, a process may need to find ways to dynamically insert the most relevant information into the final prompt. Certain embodiments apply the LLMs to build the graph structure based on the table schema, descriptions of tables/columns, and common SQL syntax operation commands. The built graph stores the own schema of the tables and the relationship between different tables. In order to solve the token limitation and ensure the accuracy of complex SQL generation, a process may use large models to expand and disassemble the user's original query, and use semantic information and graphs to filter nodes that are strongly related to each query sub-task. Certain embodiments also provide a dynamic graph scaling search algorithm to simulate SQL generation based on the calculated subgraph and obtain the final SQL statement.

Certain embodiments address at least the following problems when generating complex SQL with a large database:
(1) How to find the most relevant data tables and data columns to user queries from the large database to reduce the length of input data for avoiding the length limitation of contextual input in LLMs.
(2) How to make the model accurately generate complex query statements that match user requirements, and how to solve tasks such as multi-table joins, statistical methods, and complex keyword calculations during the SQL generation process.

Certain embodiments address the above two problems based on the graph database, combined with large language model and a dynamic graph scaling application.

In certain embodiments, an off-line hierarchical graph building process is adopted. In the hierarchical graph building process graph nodes are related to tables by at least using the primary and foreign key to establish relationships between different table nodes. The sample data and semantic information of columns are used to establish relationships between column nodes.

The hierarchical graph building process also generates an SQL syntax graph by using the LLM to extract the common SQL operation commands from database documents, such as SQL keywords, statistical commands, etc. The relationships are the dependencies and application rules between different operation commands.

The hierarchical graph building process also generates an enriched graph by mining potential business relationships between data tables based on historical queries and the table semantic information.

The hierarchical graph building process also generates a rich graph structure by determining potential relationships between tables. This may be performed by constructing an unowned foreign key relationship based on historical queries and semantic information between tables.

Online inference is performed by operations that based on user queries, retrieve, and generate subgraphs from the built graph, generate SQL and perform simulation, evaluation, and ranking.

Certain embodiments decompose user queries based on LLM, and then use a multi-step hierarchical mechanism to search for strongly related table nodes from the high-dimensional data level.

Based on the target table and column nodes, certain embodiments choose the following SQL operations to execute combined with the historical query: (1) step-by-step query; (2) Joint query; and (3) Statistical query commands.

Certain embodiments generate a sub-graph based on the matched nodes. SQL generation and simulation is performed. Certain embodiments also evaluate results of simulation based on the following metrics: (1) Syntax correctness of SQL; (2) Query performance; and (3) Correlation between query data and user query (based on LLM). Certain embodiments, sort results based on assessment scores. As a result, improvements are made to a computational device that executes database operations.

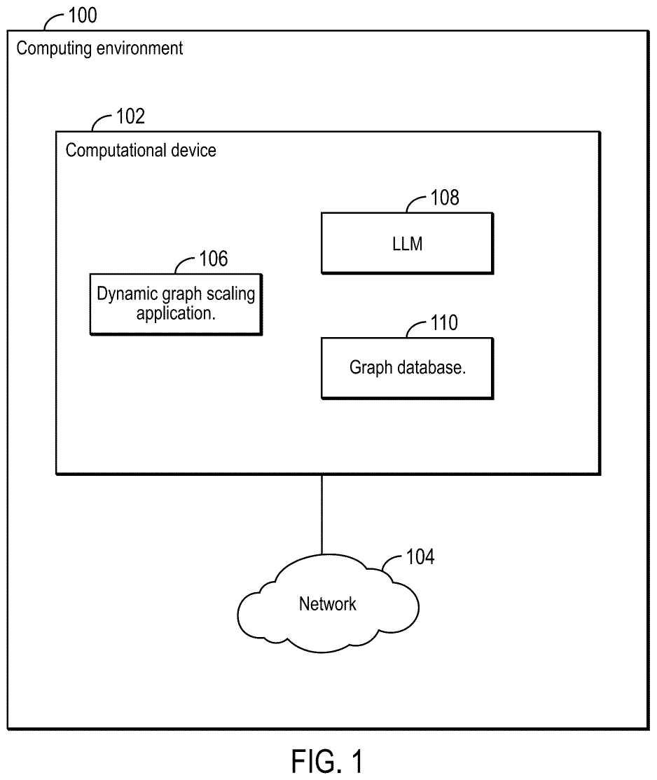

FIG. 1 illustrates a computing environment 100, in accordance with certain embodiments. At least one computational device 102 is coupled to a network 104 in the computing environment 100.

The computational device 102 executes a dynamic graph scaling application 106 that uses an LLM 108 and generates a graph database 110. In certain embodiments, the dynamic graph scaling application 106 and the LLM 108 may be implemented in hardware, firmware, software, or any combination thereof.

The computational device 102 may in certain embodiments comprise any suitable computational device known in the art such as a server, a personal computer, a laptop, a mainframe, etc. The network 104 may comprise any suitable network known in the art such as the Internet, a local area network, a wide area network, etc. Adapters, routers, switches, etc., may couple the computational device 102 to the network 104.

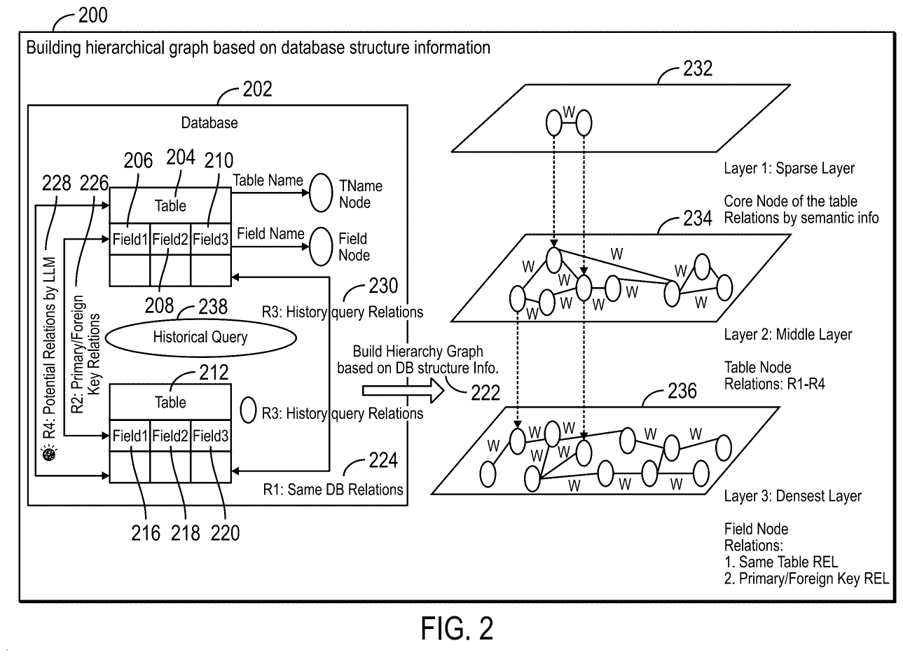

FIG. 2 illustrates a block diagram 200 that shows the building of a hierarchical graph based on database structure information, in accordance with certain embodiments.

A database 202 that includes a first table 204 and data fields referred to as Field1 206, Field2 208 and Field3 210 are shown. Also shown is a second table 212 and its data fields 214, 216, 218. Exemplary relations R1 224, R2 226, R3 228, and R4 230 are shown.

Graph Data Structure is a data structure that shows relationships between nodes. In a large number of data tables, there are complex associations between different data tables and data fields, so the traditional query method may become very tedious and inefficient. To solve this problem, embodiments provide a hierarchical graph based on data tables and database syntax graphs.

A hierarchical graph based on information related to the structure of the database 202 is built (as shown via reference numeral 222). The hierarchical graph is comprised of three layers referred to as Layer 1 comprising a sparse layer 232, Layer 2 comprising a middle layer 234 and Layer 3 comprising a densest layer 236.

The sparse layer 232 includes the core nodes of the table, and the relations by semantic information. The middle layer 234 includes the table node and exemplary relations. The densest later 236 includes fields nodes and relations including same table relations and Primary/Foreign key relations.

The node types of the hierarchical graph may include table nodes and field nodes, where if there are too many schemas, embodiments may add schema nodes and add the layer where the schema resides.

In certain embodiments, exemplary relationships include: (1) Relationship with the schema table; (2) Strong association of primary foreign keys between tables; (3) Potential table relationships based on LLM exploration (Using LLM to discover potential relationships between tables with table description and field information as input); (4) Relation with the Table field.

In certain embodiments, using the historical query record 238, the query keyword is used as the intermediate node to establish the query relationship.

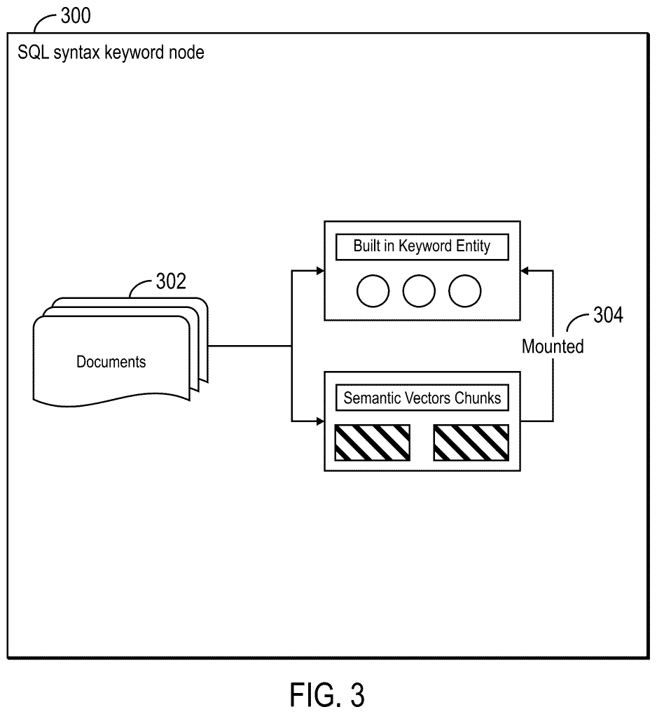

FIG. 3 illustrates a block diagram 300 that shows a SQL syntax keyword node, in accordance with certain embodiments.

SQL syntax documents 302 are rich in content, so certain embodiments extract keywords from official SQL syntax documents, development documents, and best practices based on LLM, and mount 304 these related document contents to the key word node. When the SQL is generated, the semantic information of the SQL is used to find the keyword node. Then, according to the documents corresponding to the keyword, embodiments may determine whether to use the keyword and identify the subsequent operations required for using the keyword.

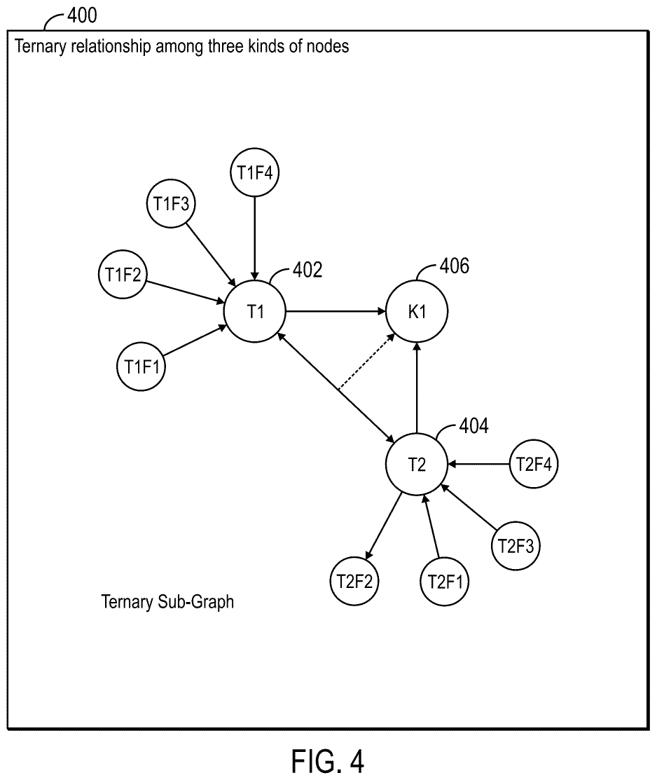

FIG. 4 illustrates a block diagram 400 that shows a ternary relationship among three kinds of nodes 402, 404, 406, in accordance with certain embodiments.

In certain embodiments, node relationships based on historical query is constructed into the ternary subgraph, so that the upper node of semantic relation may be directly navigated to specific syntactic node, and then other associated nodes may be quickly extracted.

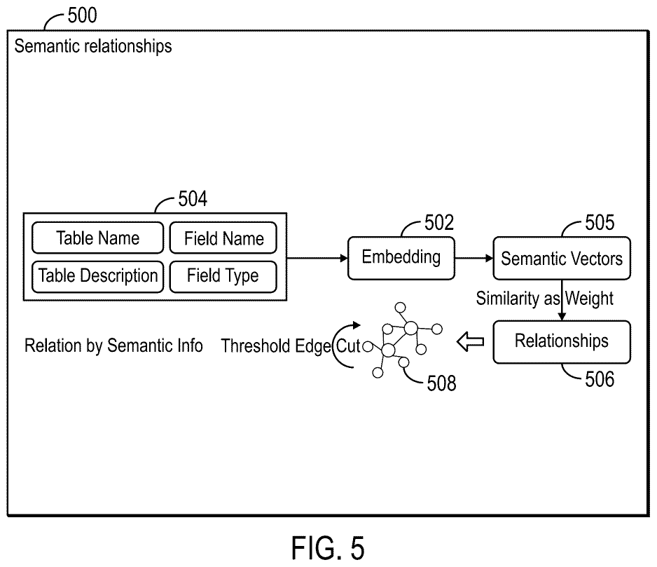

FIG. 5 illustrates a block diagram 500 that shows semantic relationships, in accordance with certain embodiments.

In addition to the primary foreign key and strong association with schema (rigid association), there are semantic and similar/close relationships (flexible association) between tables. FIG. 5 shows the association relationships based on semantics to enrich the edges between nodes.

In certain embodiments, embeddings 502 are generated from table name, table description, field name and field type (shown via reference numeral 504). From the embeddings 502, semantic vectors 505 and relationships 506 are generated and the graph 508 constructed.

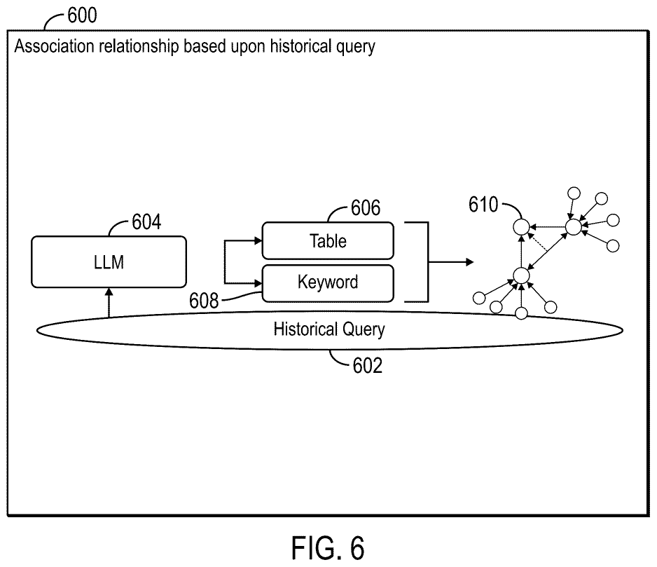

FIG. 6 illustrates a block diagram 600 that shows association relationship based upon historical query, in accordance with certain embodiments. Using historical queries 602 on the LLM 604, based on the tables 606 and keywords 608, the association relationship is generated and shown in the graph 610.

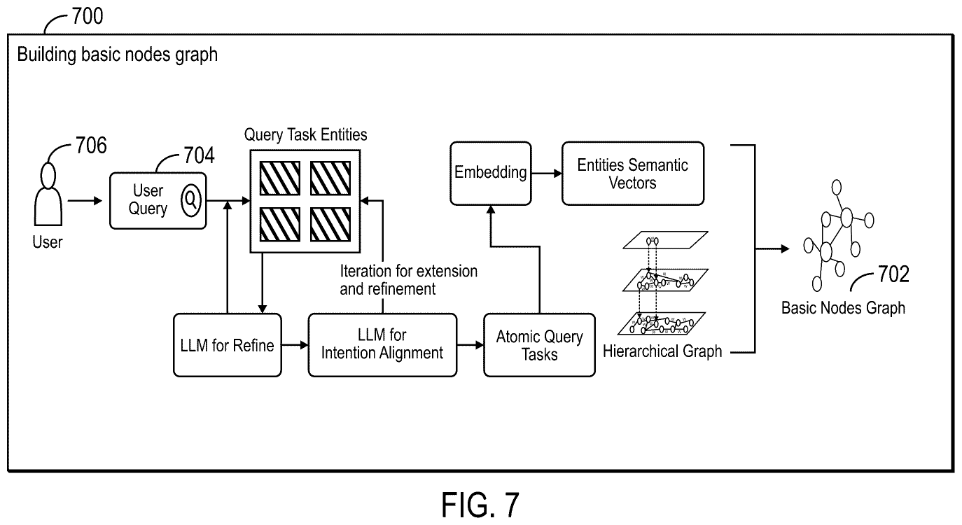

FIG. 7 illustrates a block diagram 700 that shows the building of a basic nodes graph, 702 in accordance with certain embodiments.

In real query tasks, due to the complexity of the business rules, an LLM may not understand the query 704 of a user 706. Therefore, in order to allow the LLM to better understand query tasks, operations performed in certain embodiments are based on the LLM, combined with existing table schema, and such embodiments use semantic information to decompose user queries to achieve the purpose of expanding or refining user query tasks, in order to better assist the LLM understand all user query tasks.

When expanding and refining query tasks, certain embodiments use the semantic information of the user's original query as a baseline to calculate the semantic similarity between the expanded and refined tasks and the original task, and align the intent accordingly. This controls the boundaries and scope of the LLM's expansion. The task refinement is stopped when a specified number of iterations is reached.

When a task is received, a layered search is conducted in the graph based on the semantic information of the task to find related table nodes and field nodes. Simultaneously, SQL keyword nodes are extracted based on node relationships, resulting in a basic node subgraph 702 as shown in FIG. 7.

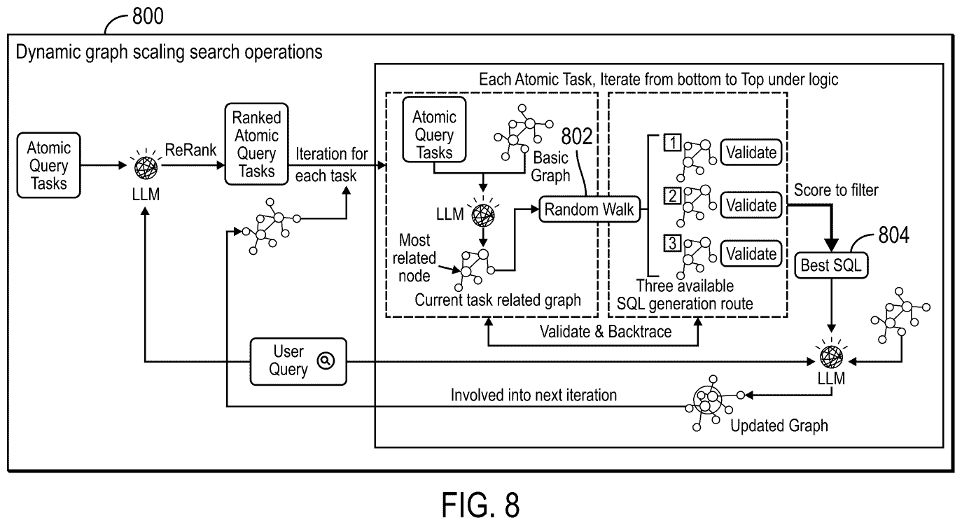

FIG. 8 illustrates a block diagram 800 that shows dynamic graph scaling search operations, in accordance with certain embodiments.

Complex user queries involve basic tasks that need to be arranged in a certain logical order to complete data queries and integration with the correct logical relationships. Certain embodiments use the existing task list and arrange the tasks using a large predictive model to obtain a task sequence.

For each query task, certain embodiments start with the node that is semantically closest to the query task, and explore nodes related to the current task by randomly walking 802 along the edges between graph nodes. After reaching a new node, certain embodiments first use the LLM to determine whether the currently visited nodes are sufficient to generate the SQL needed for the query task. Certain embodiments continue the random walk until all nodes required for the current query task are visited, then generate the SQL 804, and subsequently verify its accuracy. Based on the verification results, certain embodiments determine whether to backtrack to optimize the generated SQL.

Once the SQL for a query task in this iteration is generated, certain embodiments update the current graph based on the LLM, removing data table nodes that are no longer needed, and inserts new data table nodes into the graph based on the completed query tasks to represent the results of the underlying query tasks. The above process is repeated in cycles until all query tasks are completed.

During each random walk for node exploration, the system retains multiple results, corresponding to various SQL formulations. The purposes of this approach are to quickly locate usable nodes for verification during SQL optimization backtracking, and to ensure the accuracy of SQL generation.

These multiple results are ranked based on the following complex key performance indicators:
(1) Syntax correctness (successful execution in the database);
(2) Query response speed;
(3) Relevance of the query results to the query task;
(4) Relevance of the query results to the initial user query (task deviation and task consistency); and
(5) The path length of the involved nodes in the graph (to ensure that the generated SQL is the most concise.

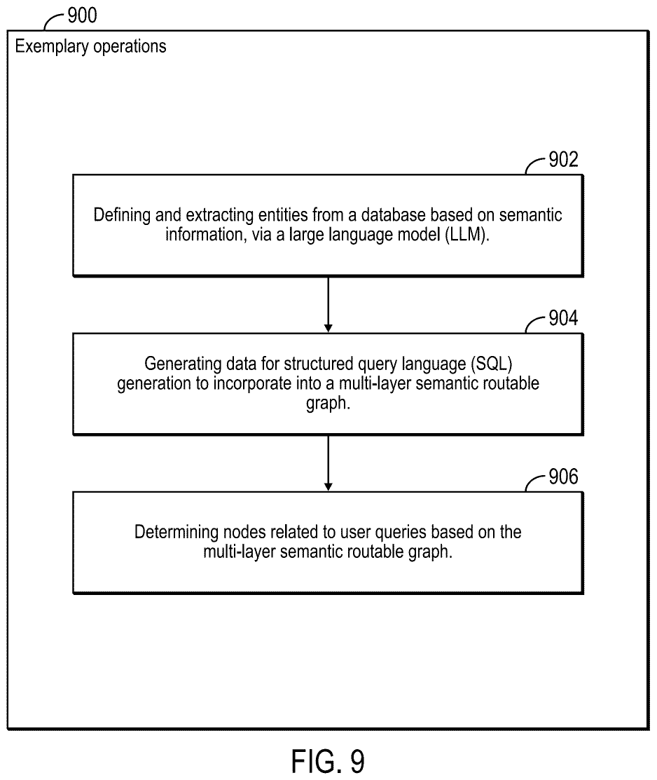

FIG. 9 illustrates a flowchart 900 that shows exemplary operations, in accordance with certain embodiments. In certain embodiments, the operations shown in FIG. 9 may be performed by the dynamic graph scaling application 106 that executes in the computational device 102.

Control starts at block 902 in which entities from a database are defined and extracted, based on semantic information, via a large language model (LLM). Data for structured query language (SQL) generation is generated (at block 904) to incorporate into a multi-layer semantic routable graph. Nodes related to user queries are determined (at block 906) based on the multi-layer semantic routable graph.

Therefore, FIGS. 1-9 illustrate certain embodiments in which by using a LLM, mechanisms are provided to define and extract entities based on semantic information, and construct data related to SQL generation into a multi-layer semantic routable graph. A ternary graph is defined to represent the relationships between tables and SQL keywords, aiding in the high-precision generation of complex SQL. The LLM is utilized to expand, refine, and decompose user query tasks. Based on the multi-layer semantic routable graph structure, nodes related to user queries are determined. A dynamic graph scaling algorithm for graph search is proposed.

Based on a graph database storing massive table data, the intricate relationships between tables, fields, and SQL keywords can be effectively maintained. By expanding and decomposing original user queries with a large language model, a more precise understanding of user query tasks is achieved, uncovering potential nested sub-queries. The layered, routable graph search algorithm utilizes semantic information and relationships between nodes to implement a graph-level “skip list query,” enabling rapid nearest neighbor node searches that may potentially be completed in milliseconds for searches involving millions of nodes.

In certain embodiments, the dynamic graph scaling applications employ a random walk mechanism to ensure the traceability of node visits, providing a safeguard for the accurate generation of SQL. By pre-filtering related data, the usage of tokens is reduced, thereby better accommodating the token limits of large language models. Fewer tokens also decrease the operational costs of large language models, enhancing the precision of task understanding.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

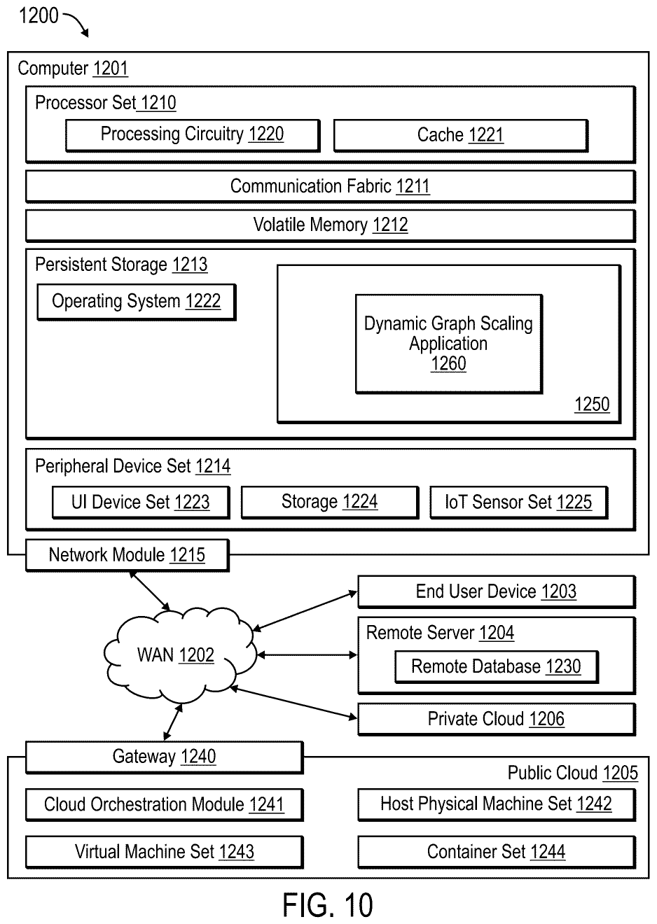

In FIG. 10, a computing environment 1200 contains an example of an environment for the execution of at least some of the computer code (block 1250) involved in performing the operations for a dynamic graph scaling application 1260 that performs operations shown in FIGS. 1-9.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IOT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 6. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A method, comprising:
defining and extracting entities from a database based on semantic information, via a large language model (LLM);
generating data for structured query language (SQL) generation to incorporate into a knowledge graph; and
determining nodes related to user queries based on the knowledge graph.

2. The method of claim 1, wherein the LLM is used to build the knowledge graph based on table schema, description of tables and columns, and SQL syntax operation commands.

3. The method of claim 1, wherein the knowledge graph stores a schema of a table, and relationships between different tables.

4. The method of claim 1, wherein the LLM is utilized to expand, refine, and decompose user query tasks.

5. The method of claim 4, wherein the knowledge graph is used to filter nodes that are strongly related to each query sub-task.

6. The method of claim 1, the method further comprising:
defining a ternary graph to represent relationships between tables and SQL keywords to generate complex SQL.

7. The method of claim 1, the method further comprising:
performing dynamic graph scaling for graph search to generate SQL generation based on a calculated subgraph and determine a final SQL statement.

8. A system, comprising:
a memory; and
a processor coupled to the memory, wherein the processor performs operations, the operations comprising:
defining and extracting entities from a database based on semantic information, via a large language model (LLM);
generating data for structured query language (SQL) generation to incorporate into a knowledge graph; and
determining nodes related to user queries based on the knowledge graph.

9. The system of claim 8, wherein the LLM is used to build the knowledge graph based on table schema, description of tables and columns, and SQL syntax operation commands.

10. The system of claim 8, wherein the knowledge graph stores a schema of a table, and relationships between different tables.

11. The system of claim 8, wherein the LLM is utilized to expand, refine, and decompose user query tasks.

12. The system of claim 11, wherein the knowledge graph is used to filter nodes that are strongly related to each query sub-task.

13. The system of claim 8, the operations further comprising:
defining a ternary graph to represent relationships between tables and SQL keywords to generate complex SQL.

14. The system of claim 8, the operations further comprising:
performing dynamic graph scaling for graph search to generate SQL generation based on a calculated subgraph and determine a final SQL statement.

15. A computer program product comprising a computer readable storage medium having computer readable program code embodied therewith, wherein the computer readable program when executed by a processor performs operations, the operations comprising:
defining and extracting entities from a database based on semantic information, via a large language model (LLM);
generating data for structured query language (SQL) generation to incorporate into a knowledge graph; and
determining nodes related to user queries based on the knowledge graph.

16. The computer program product of claim 15, wherein the LLM is used to build the knowledge graph based on table schema, description of tables and columns, and SQL syntax operation commands.

17. The computer program product of claim 15, wherein the knowledge graph stores a schema of a table, and relationships between different tables.

18. The computer program product of claim 15, wherein the LLM is utilized to expand, refine, and decompose user query tasks.

19. The computer program product of claim 18, wherein the knowledge graph is used to filter nodes that are strongly related to each query sub-task.

20. The computer program product of claim 15, the operations further comprising:
defining a ternary graph to represent relationships between tables and SQL keywords to generate complex SQL.
